(19) United States
(12) Patent Application Publication
(10) Pub. No.: US 2010/0106635 A1
(43) Pub. Date: Apr. 29, 2010

(54) CLIENT RELATIONSHIP PROFILE

(75) Inventors: Kimberly Lynn Lewis, Charlotte, NC (US); John R. Hutwagner, East Point, GA (US); Candy Elaine Jones, Bolingbrook, IL (US); Nausheen Fatima Nihal, Plano, TX (US); Raul B. Renderos, Tampa, FL (US); Mary Riley, Denver, NC (US); Stephanie F. Seugling, Concord, NC (US)

Correspondence Address: MOORE & VAN ALLEN, PLLC FOR BOFA, 430 DAVIS DRIVE, SUITE 500, POST OFFICE BOX 13706, RESEARCH TRIANGLE PARK, NC, 27709, US

(73) Assignee: BANK OF AMERICA CORPORATION, Charlotte, NC (US)

(21) Appl. No.: 12/575,270

(22) Filed: Oct. 7, 2009

Related U.S. Application Data
(60) Provisional application No. 61/107,888, filed on Oct. 23, 2008.

(51) Int. Cl. G06Q 40/00

(52) U.S. Cl. 705/35

(57) ABSTRACT

Embodiments of the present invention are directed to methods, systems and computer program products for developing a client relationship program. The method for developing a client relationship program includes determining information desired to be included in a client relationship profile, inputting client identification information into an interface and querying a plurality of operation's areas systems with the client identification information.

### CROSS REFERENCE TO RELATED APPLICATIONS

This application claims benefit of priority under 35 U.S.C. §119(e) to the filing date of U.S. Provisional Application No. 61/107,888, as filed on Oct. 23, 2008, which is incorporated herein by reference in its entirety.

### BACKGROUND

Clients often make requests that their financial institution have all of their information at their fingertips. In order to do this, an associate of the financial institution has to spend an enormous amount of time and effort researching and compiling such information for each client when the client makes such a request. The associate must research this information in several areas of the financial institution. This can be particularly challenging for newer associates who may not know the products or know what fields to request. Oftentimes, in response to submitting requests for information, the associate does not receive the information needed and has to submit repeat requests for the desired information. This complete process can take days and sometimes weeks and can be extremely inefficient. The information request can be triggered by an internal associate and/or an external client.

As such, there currently is a need for quickly obtaining detailed client information for existing and potential clients of a financial institution in order to service current clients faster, attract new clients, advise current clients on new products/services that may be of interest, and the like.

### SUMMARY

In accordance with an aspect of the present invention, a method for developing a client relationship profile includes a way to provide instant, detailed information about a client or prospect (e.g. a potential client). The method may include determining information desired to be included in a client relationship profile, inputting client identification information into an interface, selecting a plurality of disparate operation area systems of the financial institution to be queried, and querying, via the computer, each of the selected plurality of disparate operation area systems with the client identification information until the requested information is obtained.

In accordance with another aspect of the present invention, a method for creating a client relationship profile includes receiving a request for information about a client's relationship with a financial institution, and querying, using a computer, each of the plurality of disparate operation area systems in a loop until the requested information is obtained. The request may include identification information about the client of the financial institution, an indication of which products and services are to be included in the report and an indication of a plurality of disparate operation area systems of the financial institution to research.

In accordance with another aspect of the present invention, a system for developing a client relationship profile includes at least one computer specifically programmed to receive a request for information for a treasury relationship of a client of a financial institution, the request comprising identification information about the client and a plurality of disparate operation area systems of the financial institution to be queried. The computer(s) may be further programmed to query each of the selected plurality of disparate operation area systems with the client identification information until the requested information is obtained and store the obtained information into the client relationship profile so that the client's complete treasury relationship with the financial institution is accessible at a single location.

In accordance with another aspect of the present invention, an apparatus for developing a client relationship profile includes a processor, memory and at least one module. The module(s) is configured to receive a request for information for a financial relationship of a client, the request comprising identification information about the client and a plurality of operation area systems of the financial institution to be queried. The module(s) is further configured to query each of the selected plurality of operation area systems with the request until the requested information is obtained.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE DRAWINGS

FIG. 1 is a flow chart of an example of a method for developing a client relationship profile in accordance with an embodiment of the present invention.

FIG. 2 is a block schematic of an example of a system for developing a client relationship profile in accordance with another embodiment of the present invention.

FIG. 3 is a block schematic diagram of an example of another system for developing a client relationship profile in accordance with another embodiment of the present invention.

### DETAILED DESCRIPTION

Embodiments of the present invention are described below with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s) Further, the computer program instructions may be stored on a server to produce an interface on a public network (e.g. a website) and/or a private network (e.g. an intranet).

The computer program instructions may also be loaded onto a computer or other programmable data processing apparatus to cause a series of operation area steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Embodiments of the present invention are directed to methods, systems and computer program products for developing a client relationship profile. The client relationship profile is aimed at gaining a sustainable competitive advantage through profitable client relationships and continuous process improvement. The objective is to rethink and redesign the way work is done to enhance client relationships, improve process efficiencies, and the knowledge/skill sets of the workforce. It focuses on maximizing business/operations and capabilities through drastic improvement in business processes and procedures, expediting client requests, significant reduction in errors, complaints, operations costs and redundant activities and improvement in client experience and expectations and improved ability to better match the needs of a client to a particular product or suite of products based on the current relationship that client has with the Bank, external relationships (based on availability of information) and industry standards. The client relationship profile information can be used to fulfill implementation and other requests for existing clients.

The client relationship profile system covers the integrated end-to-end client sales, award and fulfillment processes for all products for credit and deposit products and services. Further, it also includes integration upstream with Product and Client Interfaces such as CashPro, BA Direct, client onboarding processes (AML, KYC, etc.), sales pipeline and deal reporting as well as downstream with service, transaction processing, and monitoring processes and systems. In one embodiment, the client relationship profile process does not include making changes to those systems. Yet further, the client relationship profile system includes integration with operations for fulfillment tasks performed outside of the client delivery and service.

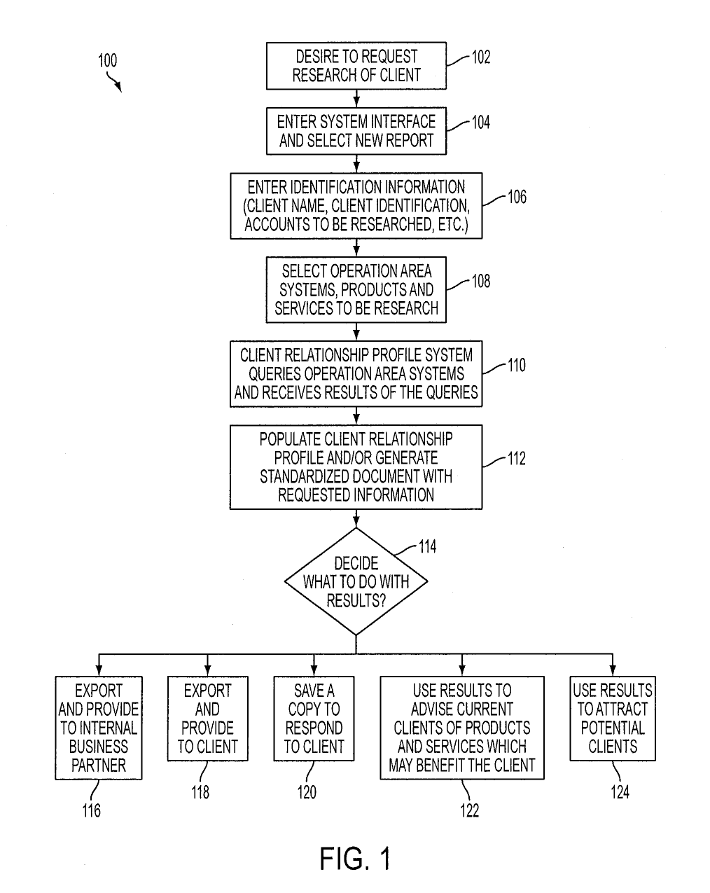

FIG. 1 is a flow chart of an example of a method 100 for developing the client relationship profile. The profile relates to a relationship between a financial institution and a current client of the financial institution, a potential client of the financial institution, and/or an internal client. Clients include various entities, such as small businesses, large businesses, corporations, middle-market companies, investment clients (including private clients, such as celebrities), individual consumers and the like. The financial institution is any entity which handles and/or manages financial assets, such as a bank, mortgage company, insurance company, brokerage, investment company, subsidiary and the like. The client relationship profile includes detailed information about the client with respect to the financial institution. For example, such detailed information may include what accounts, investments, products and services a client has with the financial institution and/or with a third party vendor. Further, detailed information may also include detailed payments and transfer processing information, detailed monitoring of processes and systems, various features of the products and services available to the client, detailed client information, information about how the client's product and services are configured and set up, and other features to give the client a complete view of their relationship with regards to treasury, credit, legal (e.g. contracts, authorizations, and other documentation) and the like.

Referring to FIG. 1, in block 102, an associate of a financial institution desires to request research on the client to develop the client relationship profile. In one embodiment, this is available on a client portal (e.g. a website, intranet, etc.) so the client, customer, and/or a third party can request certain information as well. The associate may be any representative of the financial institution or any authorized individual associated with the financial institution. Various situations may prompt the associate to research the client. For example, in one embodiment, interaction with the client may necessitate knowing detailed information about the client. In another embodiment, the client may request such information. In yet another embodiment, a sales representative of the financial institution requests information in an effort to attract a potential client. In still yet another embodiment, the associate needs to advise the client with detailed information about the client relationship with the financial institution. For example, the associate may want to advise the client about other products and services that the financial institution has that may be of interest or benefit to the client. In such situation, the associate would need to know what current products and services and other information about the client's depository and treasury relationship, all of which is provided by the client relationship profile. In yet another embodiment, the client or the Bank may need detailed information on the client in order to support a merger or acquisition, or to help facilitate other transactions upon the client's relationship with the Bank or any other third parties. Various other situations may exist where detailed information about the client or potential client is desired.

Regardless of the situation, in block 104, the associate enters into a client relationship profile system interface and selects an option to generate a new report or document. The system interface is a graphical user interface (GUI) located on a website, an intranet site, or a software application running locally on a computer. The associate selects the option to generate a report by clicking a checkbox, pulling down a file menu, selecting the option via a dropbox, and the like. In one embodiment, the system interface automatically selects the option to generate a new report upon entering the system interface or software.

In block 106, the associate enters client identification information into the system interface. The client identification information may include any information associated with the client, such as client name, client identification numbers, client account information, and/or other information that is linked with the client. The information may be entered manually or selected from a list. However, in one embodiment, the data may be entered or selected by any other individual or means, such as by the client or potential client, automatically by software/website, or by any other means. Regardless, the client identification information is received by the client relationship profile system. The interface may also search by industry code or financial product/service type; an industry and/or product comparison would result—allowing a client or prospect to understand the best product suite based on the industry.

In block 108, the associate may provide an indication or selection of operation area systems to be researched. In one embodiment, all of the operation area systems that support that client would be automatically searched as the default and the search would include all levels of the client relationship with the Bank. The operation area systems may include any databases associated with the financial institution to be researched that may be included in the client relationship profile and/or report. An operation's area may include various sections of the financial institution which may have information about the client as well as any workflow applications, which would allow the Bank to identify any work-in-process products or services. For example, operation's areas may include various client accounts, document repositories, legal documentation, products and services, such as sweep accounts, lockboxes, wires, electronic data interchange (EDI), remote deposit services (RDS), automated clearinghouse (ACH), account reconciliation processing (ARP), cash disbursement accounts (CDAs), money market demand accounts (MMDA), letter of credit, the various fulfillment solutions (Infinity, GFS) and the like. When in the system interface, the interface may provide options so that the associate may select specific products and specific services to be included in the report. In one embodiment, predetermined queries may be set up where certain operation area systems may be preselected to be researched without the associate having to select the specific systems to research. In another embodiment, a default setup may be established to research or query all operation's areas systems.

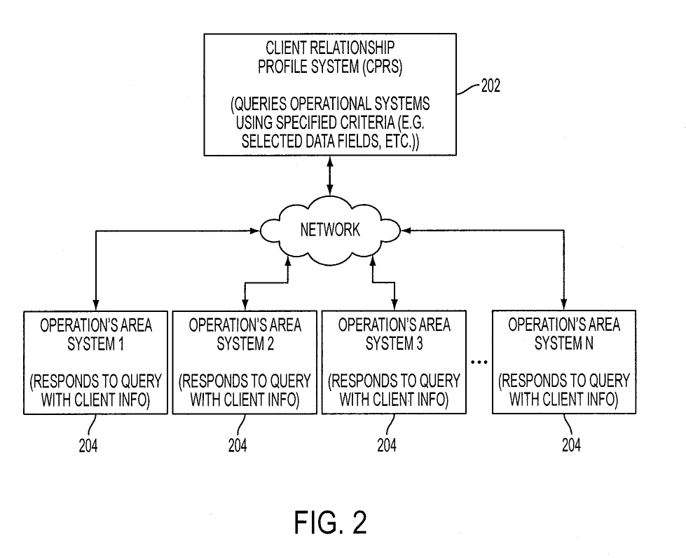

In block 110, the client relationship profile system (CRPS) queries the operation's areas systems. The CPRS may query the operation's areas systems using predefined criteria, as previously described in block 108. Referring to FIG. 2, the CPRS 202 queries a plurality of operation's areas systems 204 over a network 203, such as a local area network (LAN), a wide area network (WAN), intranet and the like. Each operation area system 204 may have a database where client information is stored and as such, the CPRS 202 may query the databases of each operation's areas system 204. It should be understood that any number of operation's areas systems 204 may be queried in order to extract the desired information from these systems 204. Any of the operation's areas systems 204 may be internal to the financial institution or may be external of the financial institution. For example, operation's areas systems (or other systems, such as financial information repository systems) external to the financial institution may include Moody's database, Hoover's database, Electronic Data Gathering Analysis and Retrieval (EDGAR) system, other federal databases, state databases, subsidiary or vendor-partner databases and other databases.

Regardless, after querying each operation's areas system 204, information associated with the client identification information is retrieved from the selected operation's areas system 204 and is transmitted back to the CPRS 202 via the network 203. The retrieved information may be stored in a database (not shown) associated with the CPRS 202. In any event, the data retrieved from the various systems 204 are compiled in a matter of minutes and saved at a single source or location. This compiled information will then be available to clients, sales staff, and other internal associates.

Referring back to FIG. 1, in block 112, the results of the query or research may populate the client relationship profile and/or be presented to the associate, client, or other representative. The CPRS may automatically populate data fields in the client relationship profile when the results are retrieved. The client relationship profile may be accessed at any time by the associate to view information about the client. Also, the results may be presented to the associate during or immediately after the query has run. For example, a standardized document or report may be generated with the retrieved information. Such document or report may be easily scanned for accuracy and presented to the client upon request. In one embodiment, a sales representative (or other individual) of the financial institution may use the CPRS to query both internal and external operation's areas systems and instruct CPRS to populate the client relationship profile and/or a report. Such data may especially be useful in attracting new clients, as described further below. The client relationship profile may also be accessed at any time during a fulfillment or service request, so that the associate has complete access to the client's/prospect's information during the onboarding process.

After the client relationship profile is complete, the associate decides what to do with the results (e.g. the client relationship profile, client information, or generated reports/documents), as shown in decision block 114. For example, in block 116, the results may be exported and provided to an internal business partner at the financial institution. Also, in block 118, the results may be exported and provided to the client. Further, in block 120, a copy of the results may be saved on the CPRS or another computer/server and be used for later purposes in responding to the client. In block 122, the results may be used in advising a current client what products and services may be beneficial to that client. In one embodiment, certain triggers may be programmed into the system so that if the profile contains a certain product or service or combination thereof, the system may automatically suggest other supporting or complimentary products/services. Such functionality may also include suggestions based on the client's industry, transaction volume, location, revenue, and other factors. Certain triggers will also be programmed into the system so that depending on client behavior or the addition or deletion of certain products or services, the client profile will be refreshed with the updated information.

In block 124, sales representatives may use the client relationship profile (which may include data from internal systems and external systems) to attract a potential client, as previously mentioned. For example, the financial institution may desire to attract potential clients from another financial institution by giving the potential client a roadmap of the transition from the other financial institution to their financial institution and the unique products and services that their financial institution may provide based viewing their client relationship profile. This would give the potential client a detailed view of exactly what the client's treasury relationship would be with the financial institution, how each product/service is set up, and that the financial institution can provide a high level of service due to knowing all details about the potential client. By way of another example, if a potential client is contemplating a merger, the financial institution may provide the potential client with information of exactly how the financial institution would execute the merger by showing the potential client the merger scenario via the client relationship profile. The financial institution can also show the potential client all of the potential products and services that the potential client can benefit from based on the client relationship profile. In any event, the results of the query may be utilized for a variety of other purposes other than those just described.

It should be understood that the client relationship profile may be expanded outside of the treasury products to credit and debt products, anti-money laundering products, and customer legal agreements associated with treasury products, consumer banking, small business banking, investments, and other aspects of relationships that financial institutions have with customers. Further, the client relationship profile may also include product and service fees, legal documentation and other information. Yet further, the client relationship profile may be able to have the ability to extract data from external sources so that the client may be able to have a more consolidated view of their treasury relationship with all of their financial institutions.

Although the above disclosure describes an associate of the financial institution performing many of the steps in developing a client relationship profile, it should be understood that other entities may perform these steps in lieu of or in combination with the associate. For example, one or more of the steps described with reference to blocks 102-108 and/or 116-124 may be performed by a client (or potential client), sales staff, customer, automatically by a computer, or by any other means.

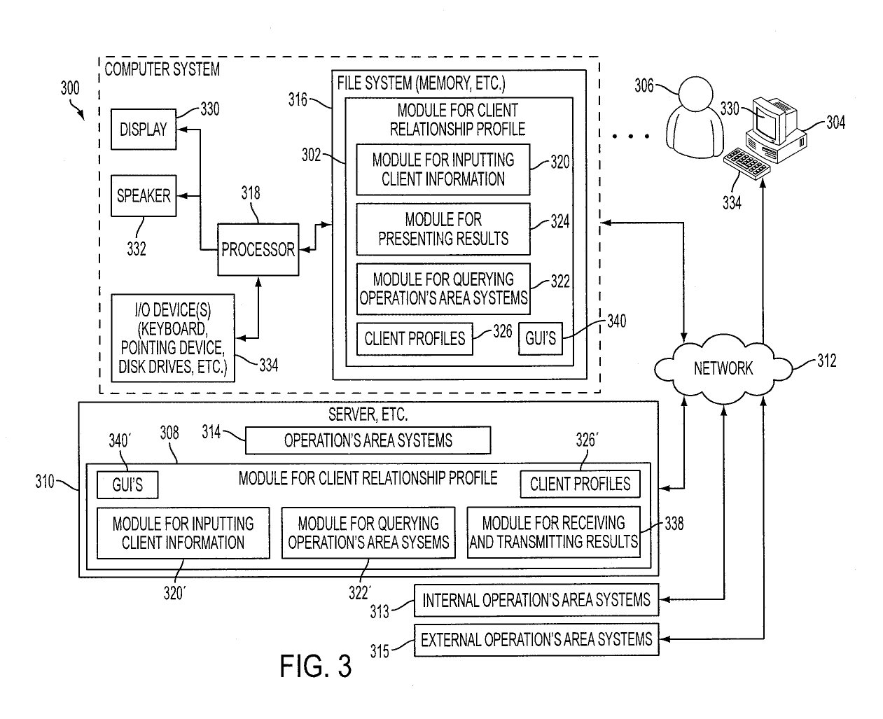

FIG. 3 is a block schematic diagram of an example of a system 300 for developing a client relationship profile in accordance with another embodiment of the present invention. The system 300 may include a module for client relationship profile 302 operable on a computer system 304, or similar device of a user 306 or client. Alternatively, or in addition to the client relationship profile module 302 on the user's computer system 304 or client, the system 300 may include a client relationship profile module 308 operable on a server 310 and accessible by the user 306 or client 304 via a network 312. The method 100 may be embodied in or performed by the client relationship profile module 302 and/or the server client relationship profile module 308. For example, the method 100 may be performed by the client relationship profile module 302. In another embodiment of the invention, the method 100 may be performed by the server client relationship profile module 308. In a further embodiment of the present invention, some of the features or functions of the method 100 may be performed by the client relationship profile module 302 on the user's computer system 304 and other features or functions of the method 100 may be performed on the server client relationship profile module 308.

One or more operation's areas systems 314 may be operable on the server 310 and may be accessible by a plurality of users 306 on their respective computer systems 304 or clients. Such operation's area systems 314 may be internal to the financial institution. Other operation area systems, including internal operation's areas systems 313 or external operation's areas systems 315, may also be located or operated outside of the server 310 or on another server separate from the server 310. The operation's areas systems 313, 314, 315 may be any system which may contain information associated with a client, or potential client, as previously described with respect to FIG. 1. The client relationship profile modules 302 and 308 may be part of the operation's areas systems 313, 314, 315 or may be separate applications or modules that interface with the operation area systems 313, 314, 315. The network 312 may be the Internet, a private network or other network, as previously mentioned. Each computer system 304′ may be similar to the exemplary computer system 304 and associated components illustrated in FIG. 3.

The client relationship profile module 302 and/or 308 may be a self contained system with embedded logic, decision making, state based operations and other functions that may operate to develop the client relationship profile. The self contained system may allow a financial institution, client, sales staff, individual, and the like to query the operation area systems and to build client relationship profiles. The module or certain components may also be added to existing sales, relationship and/or workflow management tools so that client information can be accessed during those processes. The module may also be used to feed upstream and downstream operations systems.

The client relationship profile module 302 may be stored on a file system 316 or memory of the computer system 304. The client relationship profile module 302 may be accessed from the file system 316 and run on a processor 318 associated with the computer system 304.

The client relationship profile module 302 may include a module for inputting input client identification information 320. The module for inputting client identification information 320 allows the user to input various information associated with the client, such as client name, client account information, client identification numbers, etc., into the computer system 304. The module for inputting client identification information 320 may be accessed or activated whenever the user desires to input information and may call other modules such as graphical user interfaces (GUIs) 340, as described below. The module for inputting client identification information 320 also allows input of other data fields (e.g. specific products and services, specific operation area systems to query, etc.) which may further define each query.

The client relationship profile module 302 may also include a module for querying operation's areas systems 322. As previously described with respect to block 110 of FIG. 1, the client relationship profile system (CPRS) may query one or more operation's areas systems 313, 314 and/or 315. As shown, the computer 304 may perform such operation or the server 310 may perform such operation. As such, the CPRS may be the computer 304 or server 310.

The client relationship profile module 302 may also include module for presenting results 324. The query results may be received by the computer 304 via the module for presenting results 324. As previously described with respect to block 112 of FIG. 1, the retrieved queried information may be used to populate the client relationship profile and/or to generate a standardized document or report. Such operations may be carried out by the module for presenting results 324. Other actions may be taken by the module for presenting results 324, such as exporting the results, as shown in blocks 116 and 118, saving the results, as shown in block 120, advising clients, as shown in block 122, and/or attracting new clients, as shown in block 124 of FIG. 1.

The client relationship profile module 302 may also include client profiles 326. As previously described with respect to block 104 of FIG. 1, all detailed information about a client (or potential client) or information with regard to a client relationship, such as client products and/or services, may be compiled and saved for future use. The computer may save such client relationship information into the client profiles 326. The client profiles 326 may be a database located on either the computer 304 or on the server 310. The module for presenting results 324 may access the client profiles 326 to retrieve and/or store client information via a storage system, such as a repository.

The user computer system 304 may also include a display 330 and a speaker 332 or speaker system. The display 330 may present the client relationship profile and the query results as described herein. Any GUIs 340 associated with the client relationship profile module 308 and client profiles 326 may also be presented on the display 330. The speaker 332 may present any voice or other auditory signals or information to the user 306.

The user computer system 304 may also include one or more input devices, output devices or combination input and output device, collectively I/O devices 334. The I/O devices 334 may include a keyboard, computer pointing device or similar means to control input of information for the client relationship profile search terms as described herein. The I/O devices 334 may also include disk drives or devices for reading computer media including computer-readable or computer-operable instructions.

The server client relationship profile module 308 may include a module for inputting client information 320′, module for querying operation area systems 322′, client profiles 326′ and GUI's 340′, similar to those as previously discussed with respect to the module for client relationship profile 302 located on the computer system 304. Any of these modules may be run from the computer system 304 and/or on the server 310 such that either the server 310 or the computer system 304 (or both in combination) may perform the querying functions, compiling the results of the query, and/or developing the client relationship profile.

The server client relationship profile module 308 may further include a module for receiving and transmitting results 338. This module 338 may receive the query results and direct the results to the appropriate computer system 304 for further processing or other use.

The client relationship profile modules 302, 308 may include GUIs 340, 340′, as previously mentioned. The client relationship profile modules 302, 308 may present one or more predetermined GUIs 340 to permit the user to input query parameters, such as client identification information and/or select data fields. The GUIs 340 may be predetermined and/or presented in response to the user indicating the user would like to develop a client relationship profile or a report and enter information and/or settings for the query. The predetermined GUIs 340 may be generated by the client relationship profile modules 302, 308 and may be presented on the display 330 of the computer system 304. The GUIs 340 may also include GUIs that permit a user to view query results, such as reports and/or standardized documents.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein

What is claimed is:

1. A method for developing a client relationship profile, comprising:
determining information to be requested for the client relationship profile, the requested information being associated with a client of a financial institution;
inputting into a computer identification information about the client;
selecting a plurality of disparate operation area systems of the financial institution to be queried;
querying, via the computer, each of the selected plurality of disparate operation area systems with the client identification information until the requested information is obtained; and
populating the client relationship profile with the information obtained from the querying.

2. The method of claim 1, wherein the resulting client relationship profile comprises a consolidation of the client's complete financial relationship with the financial institution.

3. The method of claim 1, wherein the requested information comprises accounts and services of the client at the financial institution.

4. The method of claim 1, further comprising generating a report with the requested information to provide a complete view of the client's treasury relationship.

5. The method of claim 4, further comprising one of:
providing the report to a representative internally within the financial institution;
exporting the report to a representative external to the financial institution; and
saving a copy of the report.

6. The method of claim 1, further comprising generating a report with the requested information to provide a complete view of the client's credit and debit card account's with the financial institution.

7. The method of claim 1, further comprising generating a report with the requested information to provide a complete view of the client's customer agreements with the financial institution.

8. The method of claim 1, further comprising generating a report with the requested information to provide a complete view of the client's anti-money laundering relationship with the financial institution.

9. The method of claim 1, wherein the client relationship profile comprises a consolidation of a client's entire treasury accounts, products and services.

10. The method of claim 1, wherein the disparate operating systems that are queried comprises operating systems external to the financial institution.

11. The method of claim 1, wherein the client relationship profile comprises a complete visual snapshot of existing account structures and configuration of services and products for each client of the financial institution.

12. The method of claim 1, wherein the querying comprises communicating with the selected disparate operating area systems until the requested information is fulfilled.

13. The method of claim 1, wherein the client comprises a potential client of the financial institution such that the client is not a current existing client of the financial institution.

14. A method for creating a client relationship profile, comprising:
receiving a request for information about a client's relationship with a financial institution, wherein the request comprises:
identification information about the client of the financial institution;
indication of which products and services to be included in the report; and
indication of a plurality of disparate operation area systems of the financial institution to research; and
querying, using a computer, each of the plurality of disparate operation area systems continuously in a loop until the requested information is obtained.

15. The method of claim 14, wherein the requested information comprises accounts and services of the client at the financial institution.

16. The method of claim 14, further comprising populating the client relationship profile with the information obtained from the querying to create a consolidation of the client's complete financial relationship with the financial institution.

17. The method of claim 14, further comprising generating a report with the requested information to provide a complete view of at least one of the client's treasury relationship, the client's credit and debit card account's with the financial institution, the client's customer agreements with the financial institution, and the client's anti-money laundering relationship with the financial institution.

18. The method of claim 14, wherein the client relationship profile comprises a consolidation of a client's entire treasury accounts, products and services.

19. A system for developing a client relationship profile, comprising:
at least one computer specifically programmed to:
receive a request for information for a treasury relationship of a client of a financial institution, the request comprising identification information about the client and a plurality of disparate operation area systems of the financial institution to be queried;
query each of the selected plurality of disparate operation area systems with the client identification information until the requested information is obtained; and
store the obtained information into the client relationship profile so that the client's complete treasury relationship with the financial institution is accessible at a single location.

20. The system of claim 19, further comprising a network configured to allow access to the client relationship profile.

21. The system of claim 19, wherein the at least one computer is further programmed to populate the client relationship profile with the information obtained from the querying to create a consolidation of the client's complete financial relationship with the financial institution.

22. The system of claim 19, further comprising an output device to output a report providing a complete view of at least one of: the client's treasury relationship, the client's credit and debit card account's with the financial institution, the client's customer agreements with the financial institution, and the client's anti-money laundering relationship with the financial institution.

23. An apparatus for developing a client relationship profile, comprising:
a processor:
memory, and
at least one module, when executed on the processor, being configured to:
receive a request for information for a financial relationship of a client, the request comprising identification information about the client and a plurality of operation area systems of the financial institution to be queried; and
query each of the selected plurality of operation area systems with the request until the requested information is obtained; and
populate the client relationship profile with the obtained information.

24. The apparatus of claim 23, wherein the at least one module being further configured to store the obtained information into the client relationship profile so that the client's complete treasury relationship with the financial institution is accessible at a single location.

25. The apparatus of claim 23, wherein the at least one module is further configured to populate the client relationship profile with the information obtained from the querying to create a consolidation of the client's complete financial relationship with the financial institution.

26. The apparatus of claim 23, further comprising an output device to output a report providing a complete view of the client's treasury relationship, the client's credit and debit card account's with the financial institution, the client's customer agreements with the financial institution, and the client's anti-money laundering relationship with the financial institution.

27. The apparatus of claim 23, wherein the operation systems are disparate operation systems.
